(19) United States
(12) Patent Application Publication
(10) Pub. No.: US 2024/0017257 A1
(43) Pub. Date: Jan. 18, 2024

(54) MICROFLUIDIC BIOSENSING PLATFORM BASED ON UPCONVERSION LUMINESCENCE

(71) Applicants: JIMEI UNIVERSITY, Xiamen (CN); JIANGSU UNIVERSITY, Zhenjiang (CN)

(72) Inventors: Quansheng CHEN, Xiamen (CN); Jizhong WU, Zhenjiang (CN); Qin OUYANG, Zhenjiang (CN); Wenya WEI, Zhenjiang (CN); Songguang ZHAO, Zhenjiang (CN); Afang ZHU, Zhenjiang (CN); Zhen WANG, Zhenjiang (CN)

(21) Appl. No.: 18/460,653

(22) Filed: Sep. 4, 2023

Related U.S. Application Data
(63) Continuation of application No. PCT/CN2023/096734, filed on May 29, 2023.

(30) Foreign Application Priority Data
May 24, 2023 (CN) 202310589390.X

(51) Int. Cl. B01L 3/00; B82Y 30/00

(52) U.S. Cl. CPC B01L 3/502753; B82Y 30/00; B01L 2300/0627; B01L 2400/043; B01L 2300/0819

(57) ABSTRACT

A microfluidic biosensing platform based on upconversion luminescence, including: an upconversion luminescence biosensor for specifically recognizing EDCs and a microfluidic chip. The microfluidic chip includes a sample injection pool, a biosensor injection pool, an arc-shaped channel, a separation channel and a detection pool. An inlet of the arc-shaped channel is communicated with the sample injection pool and the biosensor injection pool, and is configured for mixing and reacting the biosensor with the sample. The separation channel is communicated with an outlet of the arc-shaped channel, and is configured for magnetic separation of the biosensor. The detection pool is communicated with the outlet of the separation channel, and is configured for completing the enhanced luminescence-based quantitative detection of EDCs.

### CROSS-REFERENCE TO RELATED APPLICATIONS

This application is a continuation of International Patent Application No. PCT/CN2023/096734, filed on May 29, 2023, which claims the benefit of priority from Chinese Patent Application No. 202310589390.X, filed on May 24, 2023. The content of the aforementioned application, including any intervening amendments thereto, is incorporated herein by reference in its entirety.

### REFERENCE TO AN ELECTRONIC SEQUENCE LISTING

The contents of the electronic sequence listing (SequenceListing.xml; Size: 5,381 bytes; and Date of Creation: Aug. 23, 2023) are herein incorporated by reference in its entirety.

### TECHNICAL FIELD

The present disclosure relates to food safety detection, and more particularly to a microfluidic biosensing platform based on upconversion luminescence.

### BACKGROUND

Endocrine disrupting chemicals (EDCs) are defined as “exogenous agents” that interfere with the synthesis, secretion, transport, metabolism, binding or elimination of natural blood-borne hormones existing in human body that are responsible for balance, reproduction and development. Hundreds of EDCs may be received from the food production (e.g., food additives, pesticides, and food containers), industrial activities (e.g., air pollution, water pollutants, and industrial chemicals), medical treatment (e.g., medical products), etc. Among them, exogenous agents with estrogenic effects, such as bisphenol A (BPA), diethylstilbestrolum (DES), estradiol (E2), and nonylphenol, have attracted widespread attention since such EDCs may cause serious health hazards, including neurodevelopmental disorders, damage of brain, liver and lung, reproductive and endocrine disorders, and metabolic disorders. Therefore, it is important to establish an effective evaluation method to determine the content of EDCs in the media to which human beings may be exposed.

In the previous studies, the determination of EDCs content is conducted mainly based on high performance liquid chromatography (HPLC), gas chromatography (GC), electrochemical sensors, and photoelectrochemical immunosensors (PECIS). However, these determination methods often struggle with expensive equipment, strong background interference, cumbersome sample pre-treatment operation, and high reagent consumption, and thus fail to enable the on-site rapid quantitative detection of EDCs. Therefore, it is very important to develop a new detection platform to overcome the above defects.

### SUMMARY

In view of the shortcomings of the prior art, the present disclosure provides a microfluidic biosensing platform based on upconversion luminescence, which can realize micro-sampling and simple and highly sensitive quantitative detection of EDCs.

Based on this, a first object of the present disclosure is to provide a microfluidic biosensing platform based on upconversion luminescence, comprising: an upconversion luminescence biosensor for specifically recognizing EDCs and a microfluidic chip; wherein the microfluidic chip is configured as a reaction platform for the upconversion luminescence biosensor and a sample to be tested, and is configured to integrating mixing, reaction, separation and detection of the upconversion luminescence biosensor and the sample to be tested;

the microfluidic chip comprises a first injection pool, a second injection pool, a first channel, a second channel and a detection pool;

the first injection pool is configured for injection of the upconversion luminescence biosensor; the second injection pool is configured for injection of the sample to be tested; the first channel is arc-shaped; an inlet of the first channel is communicated with the first injection pool and the second injection pool; the first channel is configured for mixing and reaction of the upconversion luminescence biosensor and the sample to be tested after the upconversion luminescence biosensor and the sample to be tested enter the first channel; the second channel is communicated with an outlet of the first channel and configured for magnetic separation of the upconversion luminescence biosensor after the reaction is finished; and the detection pool is communicated with an outlet of the second channel, and is configured for enhanced luminescence-based quantitative detection of EDCs.

In an embodiment, all microchannels of the microfluidic chip have a width of 400 μm and a depth of 200 μm.

According to the above technical solution, the upconversion luminescence biosensor and the sample to be tested on the microfluidic chip are integrated in the process of mixing, reacting, separating, and detecting, which is as follows: the upconversion luminescence biosensor and the sample to be tested are injected from the two inlet pools of the microfluidic chip, and the two kinds of microfluidic fluids are sufficiently mixed and reacted in the curved channel; afterward, applying a magnetic field at the separating channel to separate the biosensor which has not reacted with the EDCs; and finally, in the detecting pool, shedding CSUCNPs completes the bridging flocculation and sedimentation and completes the collection of upconversion luminescence signals, which enables quantitative detection of the EDCs.

In an embodiment, the injection flow rates of the biosensor and the sample solution to be tested are 12 μL/min and 3 μL/min.

In an embodiment, the injection time of biosensor and the sample solution to be tested is 8-12 min.

A second object of this application is to provide a preparation method of the microfluidic biosensing platform based on upconversion luminescence, comprising:
(S1) preparing rare earth element-doped upconversion nanoparticle seeds (CUCNPs);
(S2) coating an outer layer of the CUCNPs prepared in step (S1) to prepare core-shell upconversion nanoparticles (CSUCNPs);
(S3) subjecting the CSUCNPs prepared in the step (S2) to hydrophilization to obtain hydrophilized CSUCNPs;
(S4) subjecting the hydrophilized CSUCNPs obtained in the step (S3) to obtain bio-functionalized CSUCNPs;
(S5) preparing magnetic nanoparticles (HNPs);
(S6) subjecting the HNPs to bio-functionalization to obtain bio-functionalized HNPs; and
(S7) combining the bio-functionalized CSUCNPs obtained in the step (S4) and the bio-functionalized CSUCNPs obtained in the step (S6) to prepare the upconversion luminescence biosensor.

In an embodiment, the step (S1) comprises:
dissolving yttrium chloride hexahydrate, ytterbium chloride hexahydrate and a hexahydrate of a rare earth element (REE) salt in methanol to produce a methanol solution;
adding oleic acid and 1-octadecyl to the methanol solution followed by mixing, reaction at to 150-170° C. for 25-35 min and cooling to produce a first reaction mixture;
dropwise adding a mixed solution of sodium hydroxide and ammonium fluoride to the first reaction mixture followed by reaction at 125-135° C. for 25-35 min to obtain a second reaction mixture;
heating the second reaction mixture to 290-310° C. followed by reaction at 290-310° C. for 50-60 min to obtain a third reaction mixture; and
adding ethanol and ultrapure water to the third reaction mixture followed by centrifugation to obtain the CUCNPs;

In an embodiment, the total amount of yttrium chloride hexahydrate, ytterbium chloride hexahydrate and rare earth hexahydrate is 1-1.5 mmol.

In an embodiment, when the rare earth element is erbium, the ratio of yttrium chloride hexahydrate, ytterbium chloride hexahydrate and rare earth element hexahydrate is 0.78:0.2:0.02.

In an embodiment, when the rare earth element is thulium, the ratio of yttrium chloride hexahydrate, ytterbium chloride hexahydrate and rare earth element hexahydrate is 0.795:0.2:0.005.

In an embodiment, the volume ratio of methanol, oleic acid and 1-octadecene is (5-7):(14-17).

In an embodiment, the molar ratio of sodium hydroxide to ammonium fluoride is (7-9).

In an embodiment, the volume ratio of ethanol to ultrapure water is 1:(0.6-1). In an embodiment, the centrifugation parameter is 5-10 min at the speed of 8000-1200 rpm.

In an embodiment, the step (S2) comprises:
dissolving yttrium chloride hexahydrate in methanol, followed by adding of oleic acid and 1-octadecene, mixing and reaction at 150-170° C. for 25-35 min to obtain a first reaction mixture;
cooling the first reaction mixture followed by adding of the CUCNPs, dropwise addition of a mixed solution of sodium hydroxide and ammonium fluoride, and reaction at 125-135° C. for 25-35 min to obtain a second reaction mixture;
heating the second reaction mixture to 290-310° C. followed by reaction at 290-310° C. for 20-40 min to obtain a third reaction mixture; and
adding ethanol and ultrapure water to the third reaction mixture followed by centrifugation to obtain the CSUCNPs.

In an embodiment, the amount of yttrium chloride hexahydrate is 0.35-0.45 mmol.

In an embodiment, the volume ratio of methanol, oleic acid and 1-octadecene is (2.5-3.5):(7-9).

In an embodiment, the molar ratio of sodium hydroxide to ammonium fluoride is 2:(2.5-3.5).

In an embodiment, the volume ratio of ethanol to ultrapure water is 1:(0.6-1).

In an embodiment, the centrifugation parameter is 5-10 min at the speed of 8000-12000 rpm.

In an embodiment, the step (S3) comprises:
adding the CSUCNPs prepared in step (S2) into a mixed solution of chloroform and toluene followed by adding of a polyacrylic acid aqueous solution, sealing, and reaction under stirring to obtain a reaction mixture; and
subjecting the reaction mixture to washing with ethanol and ultrapure water and centrifugation to obtain polyacrylic acid-modified CSUCNPs (PAA-CSUCNPs).

In an embodiment, the ratio of CSUCNPs, chloroform, toluene and polyacrylic acid is 50 mg:(2-6 mL):(4-10 mL):(15-20 mL).

In an embodiment, the concentration of the polyacrylic acid aqueous solution is 10-20 mg/mL.

In an embodiment, the stirring reaction time is 24-48 h.

In an embodiment, the volume ratio of ethanol to ultrapure water is 1:(0.6-1).

In an embodiment, the centrifugation is performed at 8,000-12,000 rpm for 5-10 min.

In an embodiment, the step (S4) comprises:
adding the hydrophilized CSUCNPs prepared in step (S3) into a 4-morpholine-ethanesulfonic acid (IVIES) buffer containing carbodiimide and N-hydroxysulfosuccinimide followed by incubation and centrifugation to activated hydrophilized CSUCNPs;
dispersing the activated hydrophilized CSUCNPs in a first phosphate buffered saline followed by adding of a streptavidin solution, incubation and centrifugation to obtain streptavidin-modified CSUCNPs;
dispersing the streptavidin-modified CSUCNPs in a second phosphate buffered saline followed by addition of a 5′-biotinylated EDCs aptamer incubation and centrifugation to obtain aptamer-modified CSUCNPs; and dispersing the aptamer-modified CSUCNPs in a third phosphate buffered saline followed by addition of bovine serum albumin (BSA) solution, incubation, centrifugation and washing with a fourth phosphate buffered saline to obtain the bio-functionalized CSUCNPs.

In an embodiment, the ratio of PAA-CSUCNPs, carbamide, N-hydroxysulfosuccinimide and 4-morpholine-ethanesulfonic acid buffer solution is (0.8-1.2 mg): 4 mg: 2 mg:(2.0-2.4 mL).

In an embodiment, the first incubation condition is performed at 20-40° C. for 2-4 h.

In an embodiment, the dosage of streptavidin is 0.8-1.2 mg.

In an embodiment, the second incubation condition is performed at 30-40° C. for h.

In an embodiment, the dosage of aptamer is 200-300 μL and the concentration is 10 μM.

In an embodiment, the third incubation condition is 30-40° C., 10-14 h.

In an embodiment, the dosage of bovine serum albumin is 3-6 mL and the mass fraction is 2%.

In an embodiment, the fourth incubation condition is 30-40° C., 1.5-3 h.

In an embodiment, in step (S4), the centrifugal separation parameter is centrifuged for 5-10 min at the rotating speed of 8,000-12,000 rpm.

In an embodiment, in step (S4), the pH of the phosphate buffered saline is 7.2-7.4 and the dosage is 5-15 mL.

In an embodiment, the step (S5) comprises:
adding ferric chloride hexahydrate, trisodium citrate dihydrate and sodium acetate into a glycol solution followed by vigorous stirring and transferring to a reactor for high temperature reaction; at the end of the reaction, collecting magnetic nanoparticles (MNPs) by magnetic separation followed by washing with ethanol and ultrapure water.

In an embodiment, the ratio of ferric chloride hexahydrate to trisodium citrate dihydrate to sodium acetate to ethylene glycol is 5 (mmol): 0.4 (mmol): 1.2-1.5 (g): 15-25 (mL).

In an embodiment, the reaction is performed at 190-210° C. for 8-12 h.

In an embodiment, the volume ratio of ethanol to ultrapure water is 1:(0.6-1).

In an embodiment, the step (S6) comprises:
adding the MNPs prepared in step (S5) into a-4morpholineethanesulfonic acid buffer solution containing carbamide and N-hydroxysulfosuccinimide followed by incubation and magnetic separation to obtain activated MNPs;
dispersing the activated MNPs in a first phosphate buffered saline followed by addition of a streptavidin solution, incubation and magnetic separation to obtain streptavidin-modified MNPs;
dispersing the streptavidin-modified MNPs in a second phosphate buffed saline followed by addition of a complementary sequence of a 5′-biotinylated EDCs aptamer in the 5′-biotinylated EDCs aptamer-modified CSUCNPs, incubation and magnetic separation to obtain aptamer-modified MNPs; and
dispersing the aptamer-modified MNPs in a second phosphate buffered saline followed by addition of a bovine serum albumin solution, incubation, magnetic separation and washing with a third phosphate buffered saline to obtain bio-functionalized MNP.

In an embodiment, the ratio of MNPs, carbamide, N-hydroxysulfosuccinimide and 4-morpholine-ethanesulfonic acid buffer is 8-12 (mg): 10 mg: 5 mg: 0.8-1.2 (mL).

In an embodiment, the first incubation condition is 20-40° C. for 2-4 h.

In an embodiment, the dosage of streptavidin is 0.8-1.2 mg.

In an embodiment, the second incubation is performed at 30-40° C. for 10-14 h.

In an embodiment, the dosage of the aptamer complementary sequence is 200-300 μL, and the concentration is 10 μM.

In an embodiment, the third incubation is performed at 30-40° C. for 10-14 h.

In an embodiment, 3-6 mL of a 2 wt. % bovine serum albumin solution is added.

In an embodiment, the fourth incubation condition is 30-40° C., 1.5-3 h.

In an embodiment, in step (S4), the pH of the phosphate buffer is 7.2-7.4 and the dosage is 5-15 mL.

In an embodiment, the step (S7) comprises:
adding the bio-functionalized CSUCNPs prepared in step (S4) and the bio-functionalized MNPs prepared in step (S6) into a first phosphate buffered saline followed by heating, annealing and incubation in a shaker;
subjecting an incubation system to magnetic separation to collect the upconversion luminescence biosensor; and
washing the upconversion luminescence biosensor three times with a second phosphate buffered saline followed by dispersion in a third phosphate buffered saline;

In an embodiment, the mass ratio of CSUCNPs modified by EDCs aptamer to MNPs modified by EDCs aptamer complementary sequence was (1.5-2):5.

In an embodiment, the high temperature reaction is performed at 90-95° C. for 3-5 min.

In an embodiment, the annealing is performed by reducing the temperature 60-65° C. at a rate of 3-5° C./min.

In an embodiment, the incubation conditions are 20-40° C. and 0.5-2 h.

In an embodiment, in step (S7), the pH of the phosphate buffered saline is 7.2-7.4 and the dosage is 5-10 mL.

According to the above technical solution, the aptamer-mediated nanoparticle bridging flocculation is used to realize the high-efficiency luminescence enhancement process of the upconversion luminescence biosensor; after the upconversion luminescence biosensor prepared in step (S7) is mixed with the sample solution to be tested, the aptamer is specifically combined with EDCs to cause CSUCNPs to fall off from the surface of MNPs; the biosensors that did not react with EDCs target were removed by magnetic separation, and the CSUCNPs shed in the solution reflected the number of target EDCs; the aptamer on the surface of the shed CSUCNPs is not combined with the target EDCs to generate complementary pairing of bases, resulting in aptamer-mediated bridging flocculation of nanoparticles, further sedimentation, and realizing concentration enrichment of nanoparticles; by optimizing and adjusting the focal length, the CSUCNPs signal of sedimentation is collected, and the EDCs can be quantitatively detected by luminescence enhancement.

In an embodiment, the volume ratio of the upconversion luminescence biosensor prepared in step (S7) to the sample solution to be measured is 4:1.

In an embodiment, the focal length of signal acquisition is 11.5 mm.

In an embodiment, the sedimentation time of shedding CSUCNPs is 20-30 min.

A third object of this application is to provide a method for operating the microfluidic biosensing platform based on upconversion luminescence, comprising:
preparing a plurality of EDCs standard solutions varying in concentration, wherein concentrations of the plurality of EDCs standard solutions are selected from 0-250 ng/mL; and separately injecting the plurality of EDCs standard solutions into the microfluidic chip together with the upconversion luminescence biosensor to complete mixing, reaction, separation and detection of the upconversion luminescence biosensor and EDCs;
subjecting the microfluidic chip to standing to complete bridging flocculation and sedimentation of shedding CSUCNPs; collecting a fluorescence spectrum of a CSUCNPs interface formed during the sedimentation in the detection pool by using a fluorescence spectrometer; and subjecting logarithmic values of the concentrations of the plurality of EDCs standard solutions and fluorescence signal characteristic values to linear fitting to establish a standard curve for quantification of EDCs; wherein fluorescence signal characteristic values are characteristic fluorescence intensities of a rare earth element in the upconversion luminescence biosensor for specific recognition of EDCs; and
injecting a sample solution to be tested into the microfluidic chip together with the upconversion luminescence biosensor followed by detection in the fluorescence spectrometer to collect a fluorescence signal characteristic value; substituting the fluorescence signal characteristic value into the standard curve to calculate EDCs content in the sample solution to be tested.

Compared to the prior art, the present disclosure has the following beneficial effects.

1. This application enables the significant enhancement of the fluorescence signal of the nano biosensor based on a novel aptamer-mediated nanoparticle bridging flocculation phenomenon, which further greatly improves the sensitivity of target detection by at least one order of magnitude. In addition, a stable interface is formed by the aptamer-mediated bridging flocculation of nanoparticles, which greatly reduces the influence of gravity field on the nanoparticle dispersion and effectively improves the signal stability of nano biosensors.

2. This application designs a novel microfluidic chip integrating 126 semi-circular channels and 12 quarter-circular arc channels in a limited space, which can increase the turbulence intensity of the laminar-flow microfluidic with a Reynolds number of about thereby realizing repeated mixing and reaction between the biosensor and the sample to be tested. Under the assistance of an external magnetic field the integration of mixing, reaction, separation and detection on the microfluidic chip is realized, thus greatly improving detection efficiency.

3. This application prepares an upconversion luminescence-based microfluidic biosensor, where the upconversion luminescence process can effectively avoid the background fluorescence interference of other matrices, and the use of aptamer as the bio-recognition element has good economy efficiency and specificity. After the integration into the microfluidic biosensor on the chip, micro-sampling (30 μL) and rapid detection (10 min) are realized, exhibiting a good prospect for practical on-site applications.

4. This application realizes the simultaneous detection of multiple EDCs. A single EDC component below its hazard threshold may present serious health hazards after being mixed with other EDCs, that is, there may be cumulative effects. Multicolor CSUCNPs are prepared by tuning to respectively modify specific EDCs aptamers, such that biosensors are prepared for simultaneous detection of BPA and DES with ultra-high sensitivity (0.0076 ng/mL and 0.0131 ng/mL).

### DESCRIPTION OF THE DRAWINGS

The patent or application file contains at least one drawing executed in color. Copies of this patent or patent application publication with color drawing(s) will be provided by the Office upon request and payment of the necessary fee.

In order to illustrate the technical solutions of the embodiments of this application or in the prior art more clearly, the drawings required in the embodiments will be briefly described below. Obviously, presented in the drawings are only some embodiments of this application, and other drawings may be obtained by those of ordinary skill in the art based on these drawings without making creative effort.

FIGS. 1A-F show characterization of nanoparticles prepared according to an embodiment of the present disclosure; where A is a transmission electron microscopy (TEM) image of erbium-doped CUCNPs; B is a TEM image of erbium-doped CSUCNPs; C is a TEM image of thulium-doped CUCNPs; D is a TEM image of thulium-doped CSUCNPs; E is a TEM image of MNPs; and F is a scanning electron microscopy (SEM) image of MNPs;

FIG. 2 is a TEM image of an erbium-doped biosensor;

FIGS. 3A-D show high-magnification TEM characterization of the erbium-doped biosensor, where 3A is a high-magnification TEM image; 3B is a high-angle annular dark field (HAADF)-scanning transmission electron microscopy (STEM) image; and 3C-D are energy dispersive X-ray spectroscopy (EDX) maps of iron (Fe) and erbium, respectively;

FIG. 4 is a TEM image of a thulium-doped biosensor;

FIGS. 5A-D show high-magnification TEM characterization of the thulium-doped biosensor, where 5A is a high-magnification TEM image; 5B is a HAADF-STEM image; and 5C-D are EDX maps of Fe and thulium, respectively;

FIGS. 6A-B are schematic diagrams of a microfluidic chip; where A: overall structure of the microfluidic chip; B: microchannel layout of the microfluidic chip; 1. sample injection port; 2. biosensor injection port; 3. liquid inlet channel; 4. semicircular channel; 5. connecting channel; 6. ¼-circle arc channel; 7. separating channel; and 8. detection pool;

FIGS. 7A-D schematically illustrate aptamer-mediated bridging flocculation of nanoparticles; where A shows secondary structure analysis of BPA and DES aptamers and also schematically illustrates the bridging flocculation mediated by the BPA and DES aptamers; B is a TEM of aptamer-mediated bridging flocculation of CSUCNPs; and C-D show macroscopic comparison of CSUCNPs before and after aptamer-mediated bridging flocculation (C: unexcited; and D: excited by 980 nm laser);

FIGS. 8A-C schematically show characterization of luminescence enhancement of CSUCNPs; where A schematically illustrates luminescence enhancement and spectrum of a core-shell structure constructed at the single-particle level; B is a schematic diagram of the formation of an interface during the aptamer-mediated CSUCNPs bridging flocculation; and C is a spectrum of interface-enhanced luminescence formed by the aptamer-mediated CSUCNPs bridging flocculation;

FIG. 9A show fluorescence spectra of detection of different concentrations of EDCs;

FIG. 9B shows a relationship between fluorescence signal characteristic value and DES concentration at 450 nm;

FIG. 9C shows a linear fitting curve and equation of the fluorescence characteristic value versus the logarithm of EDCs concentration; and

FIG. 9D shows the relationship between fluorescence signal characteristic value and BPA concentration at 541 nm.

### DETAILED DESCRIPTION OF EMBODIMENTS

The technical solutions of the present disclosure will be clearly and completely described below with reference to the embodiments of the present disclosure. Obviously, described below are only some embodiments, rather than all embodiments, of the present disclosure. All other embodiments obtained by those skilled in the art based on the embodiments provided herein without making any creative effort shall fall within the protection scope of the present disclosure.

The experimental methods in the following examples are conventional methods unless otherwise specified. The test materials and reagents used in the following examples are commercially available unless otherwise specified. The quantitative tests in the following examples are all performed in triplicate, and the data are expressed as mean or “mean±standard deviation”.

In addition, as used herein, “and/or” includes three solutions, for example, “A and/or B” includes A, B, and a combination thereof. In addition, the technical solutions of the embodiments may be combined with each other as long as the combined technical solution can be implemented by those skilled in the art. When the combination is contradictory or cannot be implemented, it should be considered that such combination of the technical solutions does not exist, and does not fall within the scope of the present disclosure defined by the appended claims.

### Example 1

Provided herein was an erbium-doped upconversion luminescence biosensor, which was synthesized by continuous magnetic stirring under the protection of nitrogen.

The preparation of the erbium-doped upconversion luminescence biosensor included the following steps.

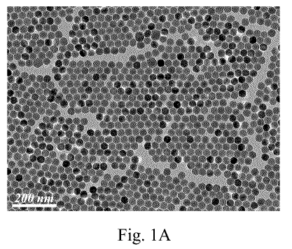

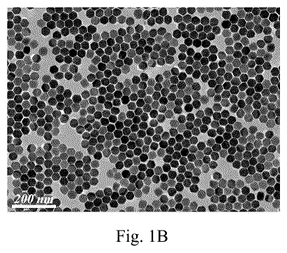

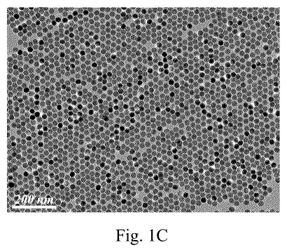

(S1) 0.78 mmol of yttrium chloride hexahydrate, 0.2 mmol of ytterbium chloride hexahydrate and 0.02 mmol of erbium chloride hexahydrate were dissolved in 10 mL of methanol, to which 8 mL of oleic acid and 15 mL of 1-octadecene were added. The reaction mixture was mixed, heated to 150° C. and reacted for 35 min. After cooled, the reaction mixture was dropwise added with a mixed solution of 2.5 mmol of sodium hydroxide and 4 mmol of ammonium fluoride, reacted at 125° C. for 35 min, and kept at 300° C. for 60 min. Then the reaction mixture was added with 10 mL of ethanol and 8 mL of ultrapure water were added, and centrifuged at 8,500 rpm for 10 min to obtain erbium-doped upconversion nanoparticle seeds (CUCNPs), whose TEM image was shown in FIG. 1A.

(S2) 0.4 mmol of yttrium chloride hexahydrate was dissolved in 10 mL of methanol, to which 3 mL of oleic acid and 8 mL of 1-octadecene were added. The reaction mixture was mixed, and reacted at 170° C. for 25 min. After cooled, the reaction mixture was added with the CUCNPs prepared in step (S1), dropwise added with a mixed solution of 1 mmol of sodium hydroxide and 1.5 mmol of ammonium fluoride, reacted at 135° C. for 25 min, and kept at 290° C. for 40 min. Then the reaction mixture was added with 10 mL of ethanol and 8 mL of ultrapure water, and centrifuged at 8,500 rpm for 10 min to obtain erbium-doped core-shell upconversion nanoparticles (CSUCNPs), whose TEM image was shown in FIG. 1B.

(S3) 50 mg of the CSUCNPs prepared in step (S2) was added into a mixed solution of 4 mL of chloroform and 6 mL of toluene, to which 20 mL of a 10 mg/mL polyacrylic acid aqueous solution was added. The reaction mixture was sealed, reacted at room temperature under vigorous stirring for 48 h, washed with 10 mL of ethanol and 10 mL of ultrapure water, and centrifuged at 9,000 rpm for 8 min to obtain polyacrylic acid-modified hydrophilic CSUCNPs (PAA-CSUCNPs).

(S4) 5 mg of the PAA-CSUCNPs prepared in step (S3) was added into a 4-morpholineethanesulfonic acid buffer (10 mL) containing 20 mg of carbamide and 10 mg of N-hydroxysulfosuccinimide. The reaction mixture was incubated at 25° C. for 3 h, and centrifuged at 8,000 rpm for 10 min to obtain activated PAA-CSUCNPs. The activated PAA-CSUCNPs were dispersed in 10 mL of a phosphate buffered saline (pH 7.2), to which 1 mL of a 1 mg/mL streptavidin solution was added. The reaction mixture was incubated at 37° C. for 12 h, centrifuged at 8,500 rpm for 6 min to obtain streptavidin-modified CSUCNPs. The streptavidin-modified CSUCNPs were dispersed in 10 mL of a phosphate buffered saline (pH 7.2), added with 200 μL of 10 μM 5′-biotinylated BPA aptamer, incubated at 37° C. for 12 h and centrifuged at 9,000 rpm for min to obtain BPA aptamer-modified CSUCNPs. Then the BPA aptamer-modified CSUCNPs were dispersed in 10 mL of a phosphate buffered saline (pH 7.2), added with mL of a 2% bovine serum albumin (BSA) solution, incubated at 37° C. for 2 h, centrifuged at 10,000 rpm for 5 min and washed with 10 mL of a phosphate buffered saline (pH 7.2) to prepare the bio-functionalized CSUCNPs, where the sequence of the BPA aptamer was 5′-Biotin-CCG GTG GGT GGT CAG GTG GGA TAG CGT TCC GCG TAT GGC CCA GCG CAT CAC GGG TTC GCA CCA-3′ (SEQ ID NO:1).

(S5) 1.3515 g of ferric chloride hexahydrate, 0.1178 g of trisodium citrate dihydrate, and 1.2 g of sodium acetate were added to 20 mL of ethylene glycol, and stirred vigorously for 30 min for full dissolution, The reaction mixture was transferred to a reactor, reacted at 200° C. for 12 h, and subjected to magnetic separation to collect magnetic nanoparticles (MNPs), which were washed with 10 mL of ethanol and 10 mL of ultrapure water. The TEM image and the SEM image of MNPs were shown in FIGS. 1E and 1F, respectively.

(S6) 100 mg of the MNPs prepared in step (S5) was added into 20 mL of 4-morpholineethanesulfonic acid buffer containing 200 mg of carbamide and 100 mg of N-hydroxysulfosuccinimide. The reaction mixture was incubated at 25° C. for 3 h, magnetically separated to obtain the activated MNPs. The activated MNPs were dispersed in 10 mL of a phosphate buffered saline (pH 7.2), added with 1 mL of a 1 mg/mL streptavidin solution, incubated at 37° C. for 12 h and subjected to magnetic separation to obtain streptavidin-modified MNPs. The streptavidin-modified MNPs were dispersed in 10 mL of a phosphate buffered saline (pH 7.2), added with 200 μL of a 5′-biotinylated sequence (10 μM) complementary to the sequence of the BPA aptamer, incubated at 37° C. for 12 h, and subjected to magnetic separation to obtain MNPs modified with the complementary sequence of the BPA aptamer. Then the modified MNPs were dispersed in 10 mL of a phosphate buffered saline (pH 7.2), added with 5 mL of a 2% BSA solution, incubated at 37° C. for 2 h, and subjected to magnetic separation and washing with 10 mL of a phosphate buffered saline (pH 7.2) to prepare bio-functionalized MNPs, where the sequence complementary to the BPA aptamer was TTT TGG TGC GAA CCC GTG ATG-3′ (SEQ ID NO:2).

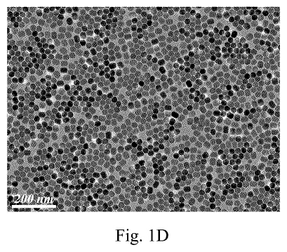

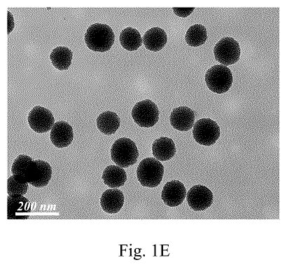

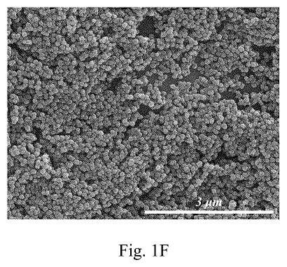

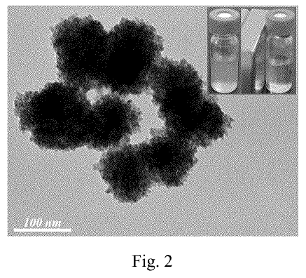

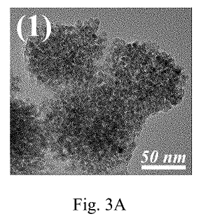

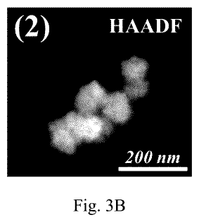

(S7) 400 μL of a 0.5 mg/mL solution of the bio-functionalized CSUCNPs prepared in step (S4) and 500 μL of a 1 mg/mL solution of the bio-functionalized MNPs prepared in step (S6) were added into 1 mL of a phosphate buffered saline, and heated at 95° C. for 3 min. Then the reaction mixture was slowly annealed to 65° C., incubated at 37° C. on a shaker for 1 h and subjected to magnetic separation to obtain an erbium-doped upconversion luminescence biosensor, which was washed three times with 10 mL of a phosphate buffered saline, and finally dispersed in 5 mL of a phosphate buffered saline. The TEM image of the erbium-doped upconversion luminescence biosensor was shown in FIG. 2, and the high-magnification TEM and EDX maps were shown in FIGS. 3A-D, indicating that the erbium-doped upconversion luminescence biosensor had been successfully prepared.

### Example 2

Provided herein was an erbium-doped upconversion luminescence biosensor, which was synthesized by continuous magnetic stirring under the protection of nitrogen.

The preparation method of an upconversion luminescence biosensor doped with thulium element included the following steps.

(S1) 0.795 mmol of yttrium chloride hexahydrate, 0.2 mmol of ytterbium chloride hexahydrate and 0.005 mmol of thulium chloride hexahydrate were dissolved in 10 mL of methanol, to which 7 mL of oleic acid and 14 mL of 1-octadecene were added. The reaction mixture was mixed, heated to 170° C. and reacted for 25 min. After cooled, the reaction mixture was dropwise added with a mixed solution of 2.5 mmol of sodium hydroxide and 4 mmol of ammonium fluoride and reacted at 135° C. for 25 min, and kept at 295° C. for 55 min. Then the reaction mixture was added with 10 mL of ethanol and 10 mL of ultrapure water were added, and centrifuged at 9500 rpm for 5 min to obtain thulium-doped up-conversion nanoparticle seeds (CUCNPs), whose TEM image was shown in FIG. 1C.

(S2) 0.45 mmol of yttrium chloride hexahydrate was dissolved in 10 mL methanol, to which 2.5 mL of oleic acid and 8 mL of 1-octadecene were added. The reaction mixture was mixed, and reacted at 150° C. for 35 min. After cooled, the reaction mixture was added with the CUCNPs prepared in step (S1), dropwise added with a mixed solution of 1 mmol sodium hydroxide and 1.5 mmol of ammonium fluoride, reacted at 125° C. for 35 min, and kept at 300° C. for 20 min. Then the reaction mixture was added with 10 mL of ethanol and 10 mL of ultrapure water, and centrifuged at 12,000 rpm for 4 min to obtain thulium-doped core-shell up-conversion nanoparticles (CSUCNPs), whose TEM image was shown in FIG. 1D.

(S3) 50 mg of the CSUCNPs prepared in step (S2) was added into a mixed solution of 4 mL of chloroform and 6 mL of toluene, to which 15 mL of a 20 mg/mL polyacrylic acid aqueous solution was added. The reaction mixture was sealed, reacted at room temperature under vigorous stirring for 36 h, washed with 10 mL of ethanol and 6 mL of ultrapure water, and centrifuged at 9,500 rpm for 7 min to obtain polyacrylic acid-modified hydrophilic CSUCNPs (PAA-CSUCNPs).

(S4) 5 mg of the PAA-CSUCNPs prepared in step (S3) was added into 12 mL of 4-morpholine-ethanesulfonic acid buffer containing 20 mg of carbamide and 10 mg of N-hydroxysulfosuccinimide. The reaction mixture was incubated at 30° C. for 2 h, and centrifuged at 9500 rpm for 6 min to obtain activated PAA-CSUCNPs. The activated PAA-CSUCNPs were dispersed in 10 mL of a phosphate buffered saline (pH 7.2), to which 1 mL of a 1 mg/mL streptavidin solution was added. The reaction mixture was incubated at 37° C. for 10 h, centrifuged at 11000 rpm for 5 min to obtain streptavidin-modified CSUCNPs. The streptavidin-modified CSUCNPs were dispersed in 10 mL of a phosphate buffered saline (pH 7.2). added with 200 μL of 10 μM 5′-biotinylated DES aptamer, incubated at 37° C. for 13 h and centrifuged at 11500 rpm for 3 min to obtain DES aptamer-modified CSUCNPs. Then the DES aptamer-modified CSUCNPs were dispersed in 10 mL of a phosphate buffered saline (pH 7.2). added with 5 mL of a 2% bovine serum albumin (BSA) solution incubated at 37° C. for 2 h, centrifuged at 10000 rpm for 5 min and washed with 10 mL of a phosphate buffered saline (pH 7.2) to prepare the bio-functionalized CSUCNPs, where the sequence of the DES aptamer was 5′-Biotin-GCC CTC TGA GGA TGC CGA AAA AGA AAA GAA ATT CTC TGG C-3′ (SEQ ID NO:3).

(S5) 1.3515 g of ferric chloride hexahydrate, 0.1178 g of trisodium citrate dihydrate, and 1.2 g of sodium acetate were added to 25 mL of ethylene glycol, and stirred vigorously for 30 min for full dissolution. The reaction mixture was transferred to a reactor, reacted at 200° C. for 10 h, and subjected to magnetic separation to collect magnetic nanoparticles (MNPs), which were washed with 10 mL of ethanol and 10 mL of ultrapure water.

(S6) 120 mg of MNPs prepared in step (S5) was added into 20 mL of 4-morpholine-ethanesulfonic acid buffer containing 200 mg of carbamide and 100 mg of N-hydroxysulfosuccinimide. The reaction mixture was incubated at 30° C. for 2 h, magnetically separated to obtain the activated MNPs. The activated MNPs were dispersed in 10 mL of a phosphate buffered saline (pH 7.2), added with 1 mL of a 1 mg/mL streptavidin solution incubated at 37° C. for 10 h, and subjected to magnetic separation to obtain streptavidin-modified MNPs. The streptavidin-modified MNPs were dispersed in 10 mL of a phosphate buffered saline (pH 7.2), added with 200 μL of a 5′-biotinylated sequence (1011M) complementary to the sequence of the DES aptamer, incubated at 37° C. for 13 h, and subjected to magnetic separation to obtain MNPs modified with the complementary sequence of the DES aptamer. Then the modified MNPs were dispersed in 10 mL of a phosphate buffered saline (pH 7.2) added with 5 mL of a 2% BSA solution, incubated at 37° C. for 3 h, and subjected to magnetic separation and washing with 10 mL of a phosphate buffered saline (pH 7.2) to prepare bio-functionalized MNPs, where the sequence complementary to the DES aptamer was GCC AGA GAA TTT CTT-3′ (SEQ ID NO:4).

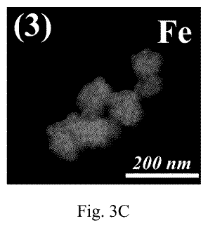

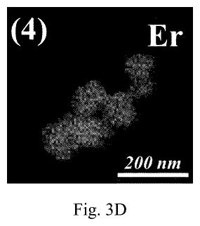

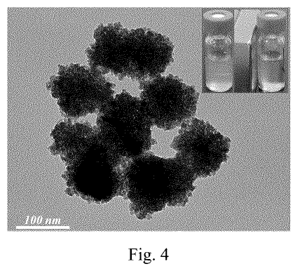

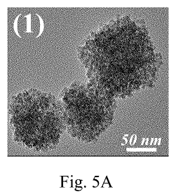

(S7) 300 μL of a 0.5 mg/mL solution of the bio-functionalized CSUCNPs prepared in step (S4) and 500 μL of a 1 mg/mL solution of the bio-functionalized MNPs prepared in step (S6) were added into 1 mL of a phosphate buffered saline, and heated at 90° C. for 5 min. Then the reaction mixture was slowly annealed to 65° C., incubated at 37° C. on a shaker for 2 h, and subjected to magnetic separation to obtain an erbium-doped upconversion luminescence biosensor, which was washed three times with 10 mL of a phosphate buffered saline, and finally dispersed in 5 mL of a phosphate buffered saline. The TEM image of the thulium-doped upconversion luminescence biosensor was shown in FIG. 4, and the high magnification TEM and EDX maps were shown in FIGS. 5A-D, indicating that the thulium-doped upconversion luminescence biosensor had been successfully prepared.

### Example 3

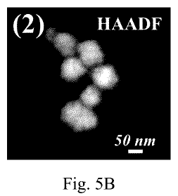

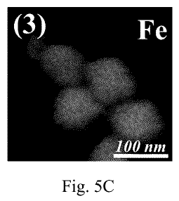

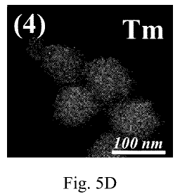

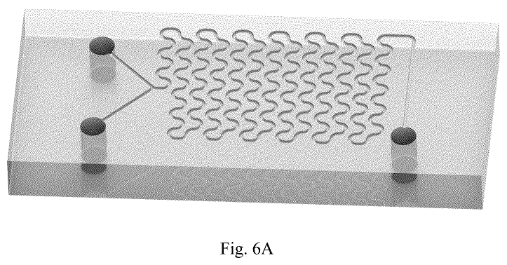

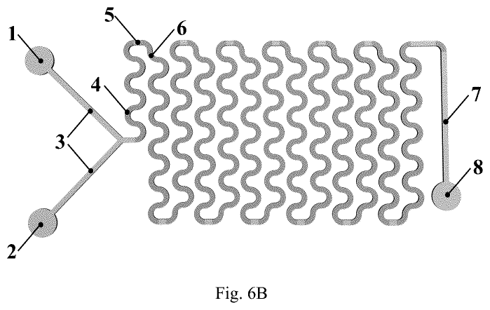

The microfluidic chip prepared by soft lithography are structurally shown in FIGS. 6A and 6B, including a sample injection port 1 and a biosensor injection port 2. The sample injection port 1 and the biosensor injection port 2 both have a circular cross-section with a diameter of 8 mm, and both have a depth of 1 cm.

The sample injection port 1 is communicated with a first end of one inlet channel 3, and the biosensor injection port 2 is communicated with a first end of the other inlet channel 3. Second ends of the two inlet channels 3 intersect at an angle of 90° and are communicated. The two inlet channels 3 are 9 mm in length.

The microfluidic chip also includes a semicircular channel 4 and a ¼-circular channel 6. The connection between individual channels is tangent connection to realize the smooth transition of the microfluid in the microchannel. The microfluidic chip also includes a connecting channel 5, whose two ends are tangentially connected with the semicircular channel 4 and the ¼-circular channel 6, respectively, to change the channel direction.

126 semicircular channels 4 (with a radius of 800 μm), 25 ¼-circular channels 6 (with a radius of 800 μm) and 11 connecting channels 5 (with a length of 500 μm) constitute the arc-shaped channel shown in FIG. 6B. An inlet of the arc-shaped channel is communicated with the intersection of the two inlet channels 3, and an outlet of the arc-shaped channel is communicated with a separation channel 7, which is a straight channel with a length of 6.8 mm. The other end of the separation channel 7 is connected with a detection pool 8, which is configured for magnetic separation of the biosensor. The detection pool 8 has a diameter of 1.2 cm and a depth of 1 cm, which is configured for bridging flocculation, sedimentation, and fluorescence signal acquisition of shedding CSUCNPs. All channels in this embodiment have a width of 400 μm and a depth of 200 μm.

Aptamer-mediated bridging flocculation and luminescence enhancement of nanoparticles were investigated as follows.

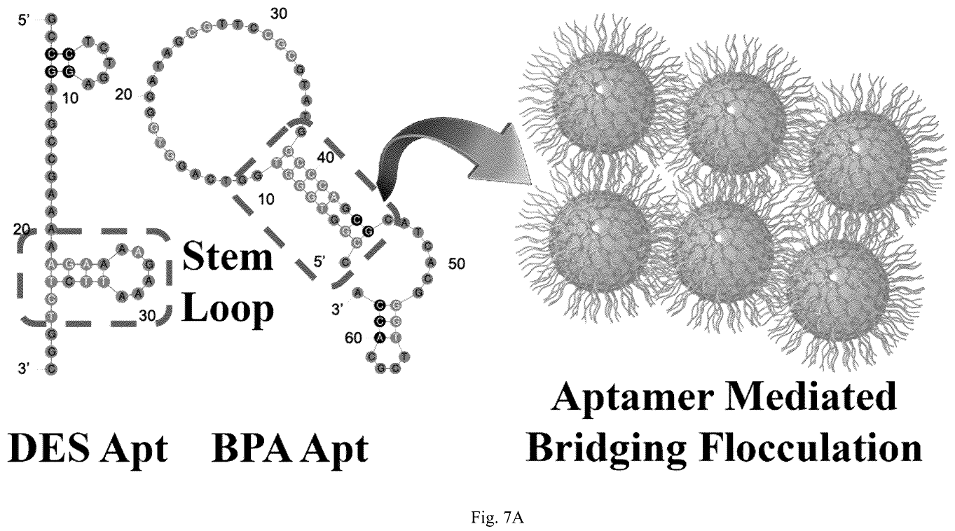

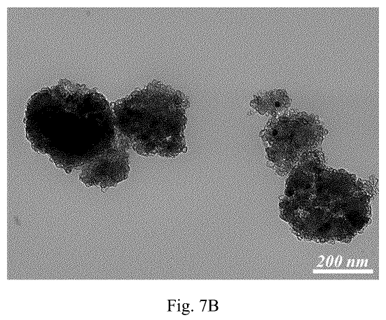

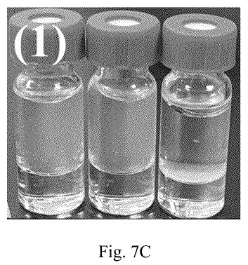

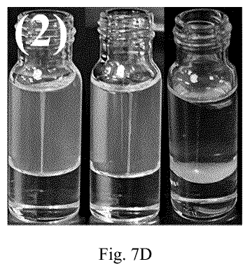

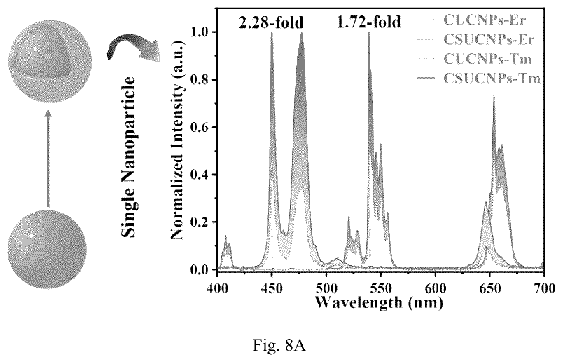

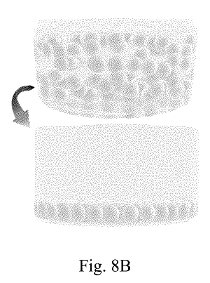

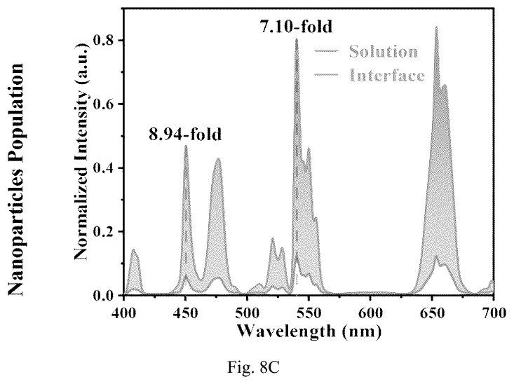

The core-shell structured CSUCNPs were prepared in Example 1 and Example 2 respectively, and the first luminescence enhancement was achieved from the single nanoparticle level, as shown in FIG. 8A, where erbium-doped CSUCNPs achieved 1.72-fold luminescence enhancement and thulium-doped CSUCNPs achieved 2.28-fold luminescence enhancement; the secondary structure prediction of DES and BPA aptamers is shown in FIG. 7A, and there is a stem-loop structure, which indicates that there are complementary paired base sequences in the aptamer sequence and can be stably hybridized, thus causing CSUCNPs modified the aptamer sequence to combine with each other to form bridge flocculation, as shown in FIG. 7A; the microscopic transmission electron microscope diagram of aptamer-mediated CSUCNPs bridged flocculation is shown in FIG. 7B, and it can be clearly observed that CSUCNPs are agglomerated from dispersed single nanoparticles (FIGS. 1A-1D) into nano aggregates; this makes bio-functionalized CSUCNPs settle into an interface from a dispersed solution state (FIG. 7C and FIG. 8B), and adjusts the fluorescence signal acquisition mode to be parallel to the gravity field direction (FIG. 7D) to realize the luminescence enhancement at the nanoparticle population level, as shown in FIG. 8C, the luminescence of the erbium-doped biosensor is enhanced by 7.10 times, and that of the thulium-doped biosensor with is enhanced by 8.94 times.

### Example 4

The biosensor based on upconversion luminescence realized simultaneous detection of BPA and DES, which was performed as follows.

(A) The upconversion luminescence biosensors prepared in Example 1 and Example 2 uniformly were mixed in equal volume to form a mixed biosensor solution capable of simultaneously recognizing BPA and DES. After that, the sample solution to be measured and the mixed biosensor solution were injected from the sample injection port 1 and the biosensor injection port 2 of the microfluidic chip respectively. The injection flow rate was 12 μL/min and 3 μL/min, and the injection time was 10 min. The two microfluids are fully mixed and reacted in the microchannel of the microfluidic chip. At the same time, magnetic field was applied to separation channel 7 to separate biosensors that did not react with BPA and DES. After that, the mixed liquid enters the detection tank 8, and the shed CSUCNPs complete bridge flocculation and sedimentation. The time for the sedimentation to reach steady state was 20 min, thus completing the collection of upconversion fluorescence signals.

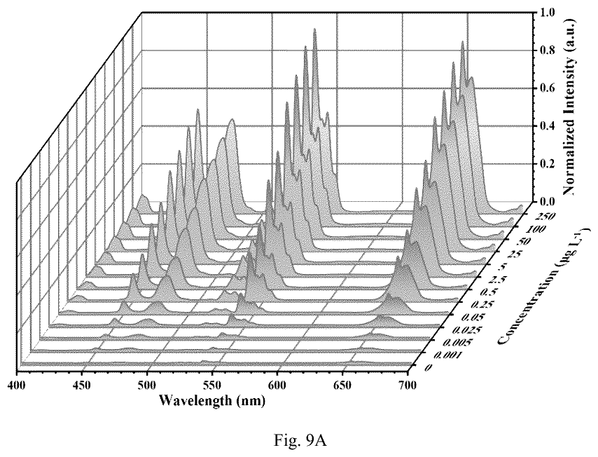

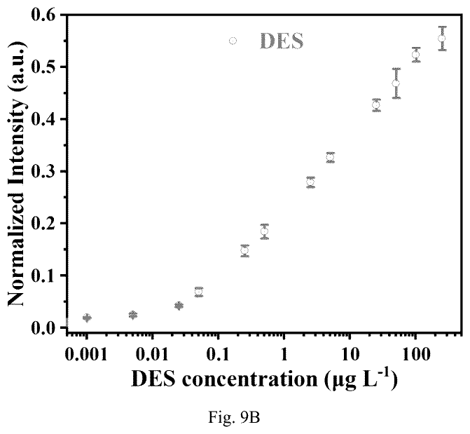

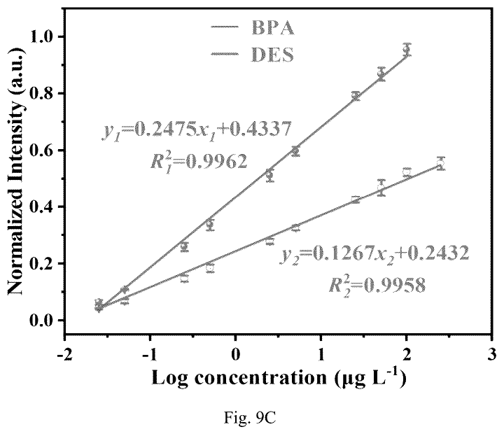

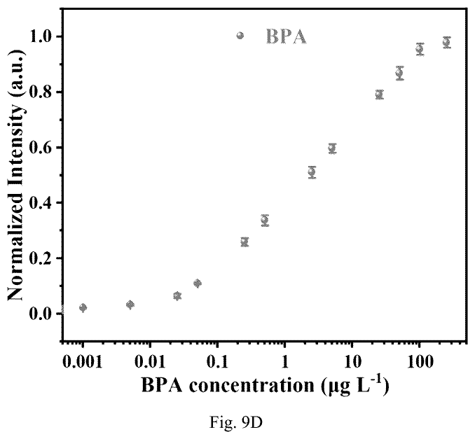

(B) A series of concentration of BPA and DES mixed standard solution of 0-250 ng/mL were injected together with the prepared upconversion luminescence biosensor into the microfluidic chip according to step (S1), and completing the steps of mixing, reaction, separation and detection of the biosensor and target EDCs. The up-turn fluorescence spectra collected by mixed standard solutions with different concentrations are shown in FIG. 9A, with the increase of BPA and DES concentrations, the fluorescence intensity at 541 nm and 450 nm gradually increases. The relationship between characteristic value 1450 of fluorescence signal at 450 nm with DES concentration is shown in FIG. 9B. The relationship between characteristic value 1541 of fluorescence signal at 541 nm with BPA concentration is shown in FIG. 9D.

(C) The fluorescence signal characteristic value was fitted to the concentration of target EDCs to obtain a linear mathematical formula for detection, as shown in FIG. 9C, the standard curve for BPA detection is fitted as y₁=0.2475x₁+0.4337, R²=0.9962, the detection range is 0.025-100 ng/mL, the detection limit is 0.0076 ng/mL, where x₁ is the logarithmic value of BPA concentration, y₁ is the Normalized fluorescence intensity of the fluorescence signal characteristic value 1450 at 450 nm; the standard curve of DES detection is fitted as y₂=0.1267x₂+0.2432, R²=0.9958, the detection range is 0.025-250 ng/mL, the detection limit is 0.0131 ng/mL, where x₂ is the logarithmic value of DES concentration, y₂ is the Normalized fluorescence intensity of the fluorescence signal characteristic value 1541 at 541 nm.

### Application Example 1

In this embodiment, the sample to be tested was seawater.

The original seawater samples were collected and centrifuged at 4000 rpm for 10 min to retain the supernatant, further filtered with a 0.45 μm filter membrane to remove impurities and used for detection.

The fluorescence signal characteristic value 1450 and fluorescence signal characteristic value 1541 detected by using upconversion luminescence microfluidic biosensing platform were 0.3592 and 0.6720 respectively, which were brought into the standard curve to calculate the contents of DES and BPA in the seawater samples as 8.24 ng/mL and 9.18 ng/mL, respectively.

In order to verify the accuracy of the detection method of the disclosure, the same experimental samples are determined by gas chromatography-mass spectrometry (GC-MS) according to the Chinese national standard GB31660.2-2019. The standard curve of BPA detection established by GC-MS is y₃=721.83x₃−6218.20, R²=0.9947, where x₃ is BPA concentration, y₃ is the peak area corresponding to BPA characteristic peak; DES test standard curve is y₄=372.07x₄−2004.95, R²=0.9953, where x₄ is DES concentration, y₄ is the peak area corresponding to DES characteristic peak.

The peak area of DES and BPA were 5585 and 7575 respectively by GC-MS, when brought to the standard curve, the contents of DES and BPA in seawater samples were 8.16 ng/mL and 7.64 ng/mL respectively.

### Application Example 2

In this embodiment, the sample to be tested was prawn.

The fresh prawn samples purchased from supermarkets were homogenized by taking 5 g of edible portion and randomly added with unknown concentrations of DES and BPA standard solutions; the prawn samples were mixed in a 50 mL centrifuge tube with 3 mL of a sodium carbonate solution and 20 mL of ethyl acetate, whirled evenly, and extracted by ultrasonic wave for 10 min; then centrifuge at 4000 r/min for 10 min, and take the supernatant into a 100 mL pear-shaped bottle; the residue was extracted with 10 mL of ethyl acetate, then the supernatant was combined with two centrifuges and evaporated to dryness at 40° C., the residue was dissolved with 5 mL of 50% cyclohexane ethyl acetate solution, and DES and BPA were extracted with 60 mg/mL solid phase extraction column; finally, the eluent of solid phase extraction column was used for detection.

The fluorescence signal characteristic value 1450 and fluorescence signal characteristic value 1541 detected by using upconversion luminescence microfluidic biosensing platform were 0.3535 and 0.6801, respectively, when brought to the standard curve, the contents of DES and BPA were 7.42 ng/mL and 9.90 ng/mL, respectively.

The peak area of DES and BPA were 5315 and 11480 respectively by GC-MS, when brought to the standard curve, the contents of DES and BPA in prawn samples were 7.79 ng/mL and 9.71 ng/mL respectively.

### Application Example 3

In this embodiment, the sample to be tested is fish.

The fresh fish samples purchased from supermarkets were homogenized with 5 g edible parts, and DES and BPA standard solutions with unknown concentrations were randomly added; fish samples were added in a 50 mL centrifuge tube with 3 mL of sodium carbonate solution and 20 mL of ethyl acetate, whirled evenly, and extracted by ultrasonic wave for 10 min; then centrifuged at 4000 r/min for 10 min, and take the supernatant into a 100 mL pear-shaped bottle; the residue was extracted with 10 mL of ethyl acetate, then the supernatant was combined with two centrifuges and evaporated to dryness at 40° C., the residue was dissolved with 5 mL of 50% cyclohexane ethyl acetate solution, and DES and BPA were extracted with 60 mg/mL solid phase extraction column. Finally, the eluent of solid phase extraction column was configured for detection.

The fluorescence signal characteristic value 1450 and fluorescence signal characteristic value 1541 detected by using upconversion luminescence microfluidic biosensing platform were 0.4462 and 0.6749, respectively, when brought to the standard curve, the contents of DES and BPA in fish samples were 40.00 ng/mL and 9.43 ng/mL, respectively.

The peak area of DES and BPA were 31959 and 10527 respectively by GC-MS, when brought to the standard curve, the contents of DES and BPA in fish samples were 36.01 ng/mL and 9.15 ng/mL respectively.

The technical features of the embodiments described above can be arbitrarily combined as long as there is no contradiction, and such combinations should be considered as falling within the scope of the disclosure. For the sake of brevity, not all possible combinations of the technical features have been described.

The above-described embodiments are merely illustrative of the present disclosure, and should not be understood as limiting the scope of this application. It should be noted that, for those skilled in the art, various variations and modifications made based on the content disclosed herein without departing from the spirit of the disclosure shall fall within the scope of the present disclosure defined by the appended claims.

What is claimed is:

1. A microfluidic biosensing platform based on upconversion luminescence, comprising:
an upconversion luminescence biosensor for specifically recognizing endocrine disrupting chemicals (EDCs); and
a microfluidic chip;
wherein the microfluidic chip is configured as a reaction platform for the upconversion luminescence biosensor and a sample to be tested, and is configured to integrate mixing, reaction, separation and detection of the upconversion luminescence biosensor and the sample to be tested;
the microfluidic chip comprises a first injection pool, a second injection pool, a first channel, a second channel and a detection pool;
the first injection pool is configured for injection of the upconversion luminescence biosensor; the second injection pool is configured for injection of the sample to be tested; the first channel is arc-shaped; an inlet of the first channel is communicated with the first injection pool and the second injection pool; the first channel is configured for mixing and reaction of the upconversion luminescence biosensor and the sample to be tested after the upconversion luminescence biosensor and the sample to be tested enter the first channel; the second channel is communicated with an outlet of the first channel, and is configured for magnetic separation of the upconversion luminescence biosensor after the reaction is finished; and the detection pool is communicated with an outlet of the second channel, and is configured for enhanced luminescence-based quantitative detection of EDCs.

2. A method for preparing an upconversion luminescence biosensor applied to the microfluidic biosensing platform of claim 1, comprising:
(S1) preparing rare earth element-doped upconversion nanoparticle seeds (CUCNPs);
(S2) coating an outer layer of the CUCNPs prepared in step (S1) to prepare core-shell upconversion nanoparticles (CSUCNPs);
(S3) subjecting the CSUCNPs prepared in the step (S2) to hydrophilization to obtain hydrophilized CSUCNPs;
(S4) subjecting the hydrophilized CSUCNPs obtained in the step (S3) to bio-functionalization to obtain bio-functionalized CSUCNPs;
(S5) preparing magnetic nanoparticles (MNPs);
(S6) subjecting the MNPs to bio-functionalization to obtain bio-functionalized MNPs; and
(S7) combining the bio-functionalized CSUCNPs obtained in the step (S4) with the bio-functionalized MNPs obtained in the step (S6) to prepare the upconversion luminescence biosensor.

3. The method of claim 2, wherein in step (S1), the CUCNPs are prepared through steps of:
dissolving yttrium chloride hexahydrate, ytterbium chloride hexahydrate and a hexahydrate of a rare earth element (REE) salt in methanol to produce a methanol solution;
adding oleic acid and 1-octadecene to the methanol solution followed by mixing, reaction at 150-170° C. for 25-35 min and cooling to produce a first reaction mixture;
dropwise adding a mixed solution of sodium hydroxide and ammonium fluoride to the first reaction mixture followed by reaction at 125-135° C. for 25-35 min to obtain a second reaction mixture;
heating the second reaction mixture to 290-310° C. followed by reaction at 290-310° C. for 50-60 min to obtain a third reaction mixture; and
adding ethanol and ultrapure water to the third reaction mixture followed by centrifugation to obtain the CUCNPs;
wherein when the rare earth element salt is an erbium salt, a ratio of yttrium chloride hexahydrate to ytterbium chloride hexahydrate to the hexahydrate of the rare earth element salt is 0.78:0.2:0.02; and
when the rare earth element salt is a thulium salt, a ratio of yttrium chloride hexahydrate to ytterbium chloride hexahydrate to the hexahydrate of the rare earth element salt is 0.795:0.2:0.005.

4. The method of claim 2, wherein the step (S2) comprises:
dissolving yttrium chloride hexahydrate in methanol followed by adding of oleic acid and 1-octadecene, mixing and reaction at 150-170° C. for 25-35 min to obtain a first reaction mixture;
cooling the first reaction mixture followed by adding of the CUCNPs, dropwise addition of a mixed solution of sodium hydroxide and ammonium fluoride, and reaction at 125-135° C. for 25-35 min to obtain a second reaction mixture;
heating the second reaction mixture to 290-310° C. followed by reaction at 290-310° C. for 20-40 min to obtain a third reaction mixture; and
adding ethanol and ultrapure water to the third reaction mixture followed by centrifugation to obtain the CSUCNPs.

5. The method of claim 2, wherein step (S3) comprises:
adding the CSUCNPs prepared in step (S2) into a mixed solution of chloroform and toluene followed by adding of a polyacrylic acid aqueous solution, sealing, and reaction under stirring to obtain a reaction mixture; and
subjecting the reaction mixture to washing with ethanol and ultrapure water and centrifugation to obtain polyacrylic acid-modified CSUCNPs (PAA-CSUCNPs).

6. The method of claim 2, wherein step (S4) comprises:
adding the hydrophilized CSUCNPs prepared in step (S3) into a 4-morpholineethanesulfonic acid (MES) buffer containing carbodiimide and N-hydroxysulfosuccinimide followed by incubation and centrifugation to activated hydrophilized CSUCNPs;
dispersing the activated hydrophilized CSUCNPs in a first phosphate buffered saline followed by adding of a streptavidin solution, incubation and centrifugation to obtain streptavidin-modified CSUCNPs;
dispersing the streptavidin-modified CSUCNPs in a second phosphate buffered saline followed by addition of a 5′-biotinylated EDCs aptamer, incubation and centrifugation to obtain aptamer-modified CSUCNPs; and
dispersing the aptamer-modified CSUCNPs in a third phosphate buffered saline followed by addition of a bovine serum albumin (BSA) solution, incubation, centrifugation and washing with a fourth phosphate buffered saline to obtain the bio-functionalized CSUCNPs.

7. The method of claim 2, wherein step (S5) comprises:
dissolving ferric chloride hexahydrate, trisodium citrate dihydrate and sodium acetate in ethylene glycol under stirring to obtain a mixed solution; and
transferring the mixed solution to a reactor followed by reaction, magnetic separation and washing with ethanol and ultrapure water to obtain the MNPs.

8. The method of claim 2, wherein in step (S4), the bio-functionalized CSUCNPs are 5′-biotinylated EDCs aptamer-modified CSUCNPs; and
step (S6) comprises:
adding the MNPs prepared in step (S5) into a 4-morpholineethanesulfonic acid buffer containing carbamide and N-hydroxysulfosuccinimide followed by incubation and magnetic separation to obtain activated MNPs;
dispersing the activated MNPs in a first phosphate buffered saline followed by addition of a streptavidin solution, incubation and magnetic separation to obtain streptavidin-modified MNPs;
dispersing the streptavidin-modified MNPs in a second phosphate buffered saline followed by addition of a 5′-biotinylated sequence complementary to an EDCs aptamer in the 5′-biotinylated EDCs aptamer-modified CSUCNPs, incubation and magnetic separation to obtain aptamer-modified MNPs; and
dispersing the aptamer-modified MNPs in a second phosphate buffered saline followed by addition of a bovine serum albumin solution, incubation, magnetic separation and washing with a third phosphate buffered saline to obtain the bio-functionalized MNPs.

9. The method of claim 2, wherein step (S7) comprises:
adding the bio-functionalized CSUCNPs prepared in step (S4) and the bio-functionalized MNPs prepared in step (S6) into a first phosphate buffered saline followed by heating, annealing and incubation in a shaker;
subjecting an incubation system to magnetic separation to collect the upconversion luminescence biosensor; and
washing the upconversion luminescence biosensor three times with a second phosphate buffered saline followed by dispersion in a third phosphate buffered saline;
wherein the bio-functionalized CSUCNPs are 5′-biotinylated EDCs aptamer-modified CSUCNPs; and the bio-functionalized MNPs are MNPs modified with a 5′-biotinylated sequence complementary to a sequence of a 5′-biotinylated EDCs aptamer in the 5′-biotinylated EDCs aptamer-modified CSUCNPs.

10. An EDCs detection method using the microfluidic biosensing platform of claim 1, comprising:
preparing a plurality of EDCs standard solutions varying in concentration, wherein concentrations of the plurality of EDCs standard solutions are selected from 0-250 ng/mL; and separately injecting the plurality of EDCs standard solutions into the microfluidic chip together with the upconversion luminescence biosensor to complete mixing, reaction, separation and detection of the upconversion luminescence biosensor and EDCs;
subjecting the microfluidic chip to standing to complete bridging flocculation and sedimentation of shedding CSUCNPs; collecting a fluorescence spectrum of a CSUCNPs interface formed during the sedimentation in the detection pool by using a fluorescence spectrometer; and subjecting logarithmic values of the concentrations of the plurality of EDCs standard solutions and fluorescence signal characteristic values to linear fitting to establish a standard curve for quantification of EDCs; wherein fluorescence signal characteristic values are characteristic fluorescence intensities of the upconversion luminescence biosensor for specific recognition of EDCs; and
injecting a sample solution to be tested into the microfluidic chip together with the upconversion luminescence biosensor followed by detection in the fluorescence spectrometer to collect a fluorescence signal characteristic value; substituting the fluorescence signal characteristic value into the standard curve to calculate EDCs content in the sample solution to be tested.


SEQUENCE LISTING (4 sequences)

SEQ ID NO: 1 - DNA, 63 bp, synthetic construct
  source 1..63: mol_type = other DNA; note = artificial sequence
ccggtgggtggtcaggtgggatagcgttccgcgtatggcccagcgcatcacgggttcgcacca

SEQ ID NO: 2 - DNA, 24 bp, synthetic construct
  source 1..24: mol_type = other DNA; note = artificial sequence
tttttttggtgcgaacccgtgatg

SEQ ID NO: 3 - DNA, 40 bp, synthetic construct
  source 1..40: mol_type = other DNA; note = artificial sequence
gccctctgaggatgccgaaaaagaaaagaaattctctggc

SEQ ID NO: 4 - DNA, 21 bp, synthetic construct
  source 1..21: mol_type = other DNA; note = artificial sequence
ttttttgccagagaatttctt